(19) United States
(12) Patent Application Publication
(10) Pub. No.: US 2017/0262879 A1
(43) Pub. Date: Sep. 14, 2017

(54) MOBILE APPLICATION AND TWO-WAY FINANCIAL INTERACTION SOLUTION WITH PERSONALIZED ALERTS AND NOTIFICATIONS

(71) Applicant: APPRIZ INCORPORATED, Wilmington, DE (US)

(72) Inventors: Pablo Cesar Elizondo Castillo, Paseo Colon, San Jose (CR); Jairo Villalobos Salas, Paseo Colon, San Jose (CR)

(73) Assignee: APPRIZ INCORPORATED, Wilmington, DE (US)

(21) Appl. No.: 14/408,269

(22) PCT Filed: Nov. 6, 2014
(86) PCT No.: PCT/IB14/03153

§ 371 Date: Dec. 15, 2014

(51) Int. Cl. G06Q 30/02; G06Q 40/02; G06Q 20/40

(52) U.S. Cl. CPC G06Q 30/0245; G06Q 20/4016; G06Q 40/02; G06Q 30/0269; G06Q 30/0267

(57) ABSTRACT

A platform, a method and a cloud data interaction product with customized alerts, fraud alerts,notifications, services, promotions and communication between financial institutions and their clients. The invention is a solution that allows the user to integrate information from several financial institutions, through all channels and for all financial products such as credit and debit cards, checking accounts, savings accounts, insurance policies, loans, investments and others. In addition, it creates a bridge for all channels used by clients, such as mobile devices, ATMs, electronic banking, IVR, POS and others

### BACKGROUND OF THE INVENTION

Users of a financial system will often want to be informed of all transactions that have an impact on the businesses that connect them with the financial institution.

Financial institutions around the world currently offer their clients alerts. However, these alerts are very limited and are designed to warn about the occurrence of an event, providing no additional information nor taking into account the historic transactional profiles of the client. Furthermore, these notifications are unidirectional and do not allow the client/user to act on them in a timely manner.

U.S. patents US20080167017 and US20110066505 consist of payment systems that send alert messages to your phone. However, these alerts are designed solely to report any payment transactions carried out, or the balance of payments, and do not offer the user a personalized alert based on logic, data analysis or information determining that a series of conditions have been met.

Similarly, U.S. patent US22050038744 consists of an operational system in which you can carry out bank transactions that are received and verified through a call center. With this system, clients of the financial institution are informed of these transactions via a text message, but there is no possibility of a two-way communication between the user and the financial institution nor does it allow for the interaction of other multichannel applications.

U.S. patent US20100191602 (ref. U.S. Pat. No. 12/456,343) claims a mobile banking and mobile payment system that includes dual channel communication between the bank and the client, through which the client may respond to specific alerts but it does not integrate the systems in a manner that allows the platform to crossover information or to customize the alerts for each individual client, rendering this a previously known art, with limitations.

Considering that the present invention also incorporates customized alerts for advertising, the prior art has its precedent in U.S. patent US20120089465, which introduces a system to store and retrieve advertising on a mobile phone. However, this system does not offer the user the opportunity to customize the alert options or to link them to their financial services.

Patent 20110295731 claims a system that sets up reminder alerts based on the financial performance of user's accounts; that is to say, future events that the bank considers the user will carry out. However, this previous technology does not address the possibility for a user or client of a financial institution to receive reminder alerts from the financial institution or to establish personal settings for reminder alerts based on the regularity, content and activity of the transactions that take place, which are immediately reported, giving the client the opportunity to interact directly with the financial institution.

### DETAILED DESCRIPTION OF THE INVENTION

After working on solutions for fraud prevention in more than 140 institutions in the Americas for over 12 years, a study on the financial solutions and their technical architecture was carried out in order to assess market needs and to generate value in the industry through a tool tailored to these needs.

Having developed a successful mechanism to determine behavior patterns, for data mining and advanced statistics for consumer analyses and venturing into cloud software architecture, such as mobile applications and “big data”, we chose to analyze the feasibility of a single platform for financial institutions that would comprehensively address the connection with clients in an effective, safe, personalized and productive manner.

To do this, we thought about a change in paradigm in order to involve users in the transactional monitoring of all financial products and the possibility of defining their own alerts proactively, instead of placing all the responsibility on the banks, thus taking the virtual relationship to a whole new level.

The present invention relates to a platform we call APPRIZ that enables, in an interactive and cost effective manner, the communication between financial institutions and their clients, integrating a variety of financial products such as credit and debit cards, checking accounts, savings accounts, insurance, loans, investments and others. In addition, it creates a bridge for all channels used by clients, such as mobile devices, ATMs, electronic banking, IVR, POS and others.

This is the only interactive platform with core technology that allows for an alert that is generated as a result of a number of transactions or events that occur at different points in time, with respect to a single user. The platform applies a logic or intelligence defined by the financial institution and the user to generate these alerts. The alerts allow the user to establish a response action (generating a two-way communication), resulting from notifications from the financial institution to the client, which also enables a two-way communication.

The interactions allowed with this platform are not based on a single event but on several events occurring between transactions, thereby adding a dimension of time while also allowing the user to establish the number of transactions that should generate an alert as well as the individual combined amounts thereof. In addition, the events are generated both by the client and the financial institution, generating a two-way communication that allows the client to automatically respond to each alert immediately upon receipt.

The platform design is based on several client products within the financial institution, combining data and information within the alert parameters previously established by the client and generated by the financial institution.

The first analyzes multiple events to generate alerts. The transactions or events on which the alerts are based are pre-programmed, analyze similar occurrences and are analyzed and combined based on the parameters established by the user.

A customizable alert system;

A fraud alert system;

A notifications system;

A service system;

A promotional system.

The platform also permits the interaction of services from different banks while maintaining the logo, colors and brand differentiators for each one.

1. Personalized Alerts

A personalized alert system lets the clients of a financial institution monitor their transactions in real time. The financial institution creates alert templates with a number of parameters that classify the financial products and specific analytical conditions, up to the most detailed level of a financial transaction, while establishing specific actions that the client may choose from, once the alert occurs. From these templates, clients configure their settings based on three aspects: number of transactions, individual or combined amount of said transactions and time period.

Every time the rules parameterized by the client are broken or whenever there is unusual activity linked to the client's exclusive account—even across multiple products, channels and transactions—an alert is sent to the consumer, using the Appriz platform. Each alert displays a set of options related to the situation as well as details pertaining to the specific transaction.

Based on the alert and the rules associated with it, the Platform directs the client to take specific and immediate action to address the situation, allowing the client to, through the platform, block the account, block access to ATMs and may even block contact with the financial institutions customer service department, thus generating a two-way communication between the user and the financial institution.

2. Fraud Alerts

This platform feature allows for the notification of potential situations of fraudulent activity detected by the financial institutions internal systems as well as the opportunity of an immediate response from the user. Appriz allows the connection of the internal fraud prevention systems with the alert platform, so that the financial institution can easily establish which notifications and what actions will be made available to make a decision. These actions may include, for example, blocking the account, blocking access to ATMs, stop payments and transfers or even blocking contact with the financial institutions customer service department.

Examples of alerts of this nature may include: bank account transfers that do not comply with the clients behavioral profile, credit card transactions, the cashing of multiple checks in different branches or for determined amounts or within a specified period of time, three unsuccessful attempts to access the account, transactions in certain establishments (for example, gas stations, jewelry stores and electronics stores), etc.

3. Services

Allows the financial institution to parameterize the steps available to all clients according to their classification within the existing mobile banking services offered by the financial institution. The implementation of the services requires the use of a password on your smartphone.

The services most often available include: request of bank statements; balance inquiries for checking accounts, savings accounts, loans; information regarding payment due dates for credit cards, full payments and minimum payments; exchange rate for client specific dates; requests for one-time passwords; requests for replacement cards; requests for the replacement of lost or stolen cards; requests for increases in credit card limits; requests for checkbooks; requests to block accounts or cards; interest rates and general financial information, among others.

4. Notifications

Through the notifications service, direct communication is established between the financial institution and the client, in order to send specific messages related to products and services that the client has with the financial institution and through which a response can be requested through a set of available options.

Among the added value services offered to the clients of financial institutions, we have: information regarding the status of car loans or leasing, reminders of payment dates for credit cards or loans, expiration of certificates and requests for their renewal or cancellation, messages regarding payroll deposits, expiration dates for life insurance policies, requests related to products, among others.

5. Promotions

The platform includes a feature to offer promotions, unlike what can be found in prior art, which allows the financial institution to make a two-way cross sale:
a) Directly to clients through messages that may be general for a specific audience or specific for a client, based on a set of behavior patterns observed in the client, based on spending habits.
b) Through promotional banners that adapt to the parameters established for the account on the platform's administration console.

Clients can read and even respond to the promotions, immediately or at any other time by using the platform to access them. Each campaign can also be measured using business intelligence elements, thus allowing to measure the business impact of the campaign and to adjust it according to the results.

How Does the Platform Work?

The client interacts with a single platform that can be consolidated in one App for a smart device, offering a comprehensive solution for banking services, operating in any of the known systems: Apple's iOS and Google's Android.

The system components are safeguarded in the cloud, allowing the financial institution to manage the system through a conventional browser.

The information management program in the cloud makes it possible to offer services including behavioral profiling, the analysis of transactions, messaging and communications.

Each financial institution is assigned a processing capacity according to expected transaction volumes and growth expectations. If client transactions unexpectedly increase, the cloud system automatically expands to allow for the increase in processing.

The program has been designed to manage millions of transactions simultaneously and the transactional information pertaining to each institution is stored individually.

The information belonging to the financial institution is encrypted both in its transmission and storage, for maximum security.

The messaging system in the cloud helps take advantage of the strength and security of the notifications made through this platform to smart devices.

The platform itself gathers and synthesizes information from all transactions in real time and organizes said information according to the settings established by the client and the financial institution, consolidating and integrating the data received from multiple sources that feed the system. The information is then transferred to the cloud over a secure connection and on to the client's mobile devices.

From the perspective of the financial institution, the platform provides an administrative console that allows the management of a variety of financial services including: the management of security, user registration, access privileges for management, customer management, inclusion and loss of clients, the creation of alert criteria, products, settings for alerts based on client and product, promotions management, campaign management, campaign duration, the delivery of messages, personalized messages for clients, product advertising, key performance indicators (KPIs), graphs and statistics related to client activity.

Appriz Components Diagram

The elements that make up this innovative tool are described as follows:
Console. Is a web application that allows the administration and configuration of the Appriz platform, as well as the capture and maintenance of the information that must be provided by each financial institution.
Setup. Is the service that allows the performance of operational tasks for the Appriz configuration.
Download. Is a service charged with the distribution of information or requests in Appriz. Performs the mapping to the components responsible for the processing.
Alert Builder. Builds all the alerts and notifications to be sent to mobile clients (Smartphones).
Appriz Repository. Appriz central repository with information related to operating system.
Evaluation Repository. Stored transactions and fundamental data for the transactional evaluation of My Alerts.
Data Sources. Are the information sources of a customer in Appriz.
Exporter. The component responsible for operating the Appriz user rules after a modification is done. Its main objective is to get the latest version in the shortest possible time.
Evaluation Engine. Responsible for the evaluation of the customer transaction data and the rules defined by the end user.
Admin. The person in charge of Appriz in the financial institution (client).
Services. Service responsible for the transactional transit or inquiries generated by mobile clients.
Integration. Services in charge to deliver information from the financial institution to Appriz.
   SDK. It's a software development kit that enables a smooth construction of the Appriz Sources to generate the information necessary to Appriz.
   ETL. It's a solution to perform data replication to a base structure, which is responsible for transfer to Appriz.
   Flat Files. It's a solution that allows sending from ApprizSources content directly using flat files.

1. A technological platform for two-way data interaction through messaging to smart devices, with core technology including:
A customizable alert system;
A fraud alert system;
A notifications system;
A service system;
A promotional system.

2. A platform according to claim 1, wherein all systems share one core technology.

3. A platform according to claim 1, wherein the core technology features:
The management of information in the cloud for multiple transactions, simultaneously;
a data administration console for the financial institution;
the calculation of the programmed functions carried out by the user.

4. A platform according to claim 1, wherein the two-way interaction takes place between a financial institution and the users of its services.

5. A platform according to claim 1, wherein the messaging system is specific to the platform on which data frames are parametrically defined by the platform provider and the financial institution.

6. A platform according to claim 1, wherein the notification system allows the financial institution to execute all types of one-way or two-way personalized notifications for its users.

7. A platform according to claim 1, wherein the personal alert system allows for the analysis of multiple related transactional events carried out at different points in time, taking into consideration the performance profiles established by the financial service user to program personal alerts and to receive them when they occur.

8. A platform according to claim 1, wherein the parameterization system for personal alerts can generate personal alerts pertaining to any financial product that is carried out through any available channel, including: information regarding payroll deposits received, changes in rates or currency within an investment portfolio or shares; the inclusion or modification of favorite accounts for transfers; modifications to personal data in accounts; information regarding the completion of a defined number of transfers for amounts and dates previously defined by the user; the submission of more than one previously defined number of checks for amounts and on dates previously established by the user; notification of withdrawals made at ATMs for amounts established by the user, within a certain amount of time; notification of an account balance below an amount determined by the user; notification of incoming transfers or deposits to accounts for amounts greater than the amount of money defined by the user; notification of transactions carried out with a personal credit card or additional credit cards in establishments defined by the user and for amounts greater than those defined by the user.

9. A platform according to claim 1, wherein the personalized alert system allows the user to interact with the financial institution by responding to notifications through a series of actions previously established by the financial institution.

10. A platform according to claim 1, wherein the fraud alert system allows for communication with the user regarding financial services as well as fraud monitoring and prevention related to a specific transaction or group of transactions.

11. A platform according to claim 1, wherein the fraud alert system allows the user to act on or issue a response through a series of actions previously established by the financial institution, which may include: blocking the account, blocking withdrawals from ATMs, stop payments and transfers between accounts and /or blocking contact with customer service.

12. A platform according to claim 1, wherein the service system allows the financial institution to parameterize the steps available to all clients according to their classification in the existing mobile banking services within the financial institution.

13. A platform according to claim 1, wherein data reception is carried out through two-way notifications, alerts and promotions, through messaging on a smart device.

14. A platform according to claim 1, wherein the promotional system includes:
A system of direct communication with the user through messages;
A system of indirect communication with the user through promotional banners that are visible when the user checks alerts, messages or carries out any other tasks within the mobile application.

15. A platform according to claim 1, wherein the promotional system allows the generation of services related to advertising, letting the user choose according to parameters previously defined by the financial institution.

16. A platform according to claim 1, wherein the promotion system is parameterized by the financial institution with regard to sequence, display time on screen, customer classification (market niche), start date and end date.

17. A platform according to claim 1, which allows the performance analysis of each promotional campaign according to the response generated by the users.

18. A platform according to claim 1, wherein an App for smartphones, tablets and all other mobile devices can be developed.

19. A comprehensive two-way method of financial data interaction through messaging to smart phones, which includes core technology that links:
A customizable alert system;
A fraud alert system;
A notifications system;
A service system;
A promotional system.

20. A smart device with a platform according to claim 1.

21. A smart device with a platform according to claim 1, using a comprehensive two-way method of financial data interaction through messaging to smart phones, which includes core technology that links:
a customizable alert system;
a fraud alert system;
a notifications system;
a service system; and
a promotional system.
